(19) United States
(12) Patent Application Publication
(10) Pub. No.: US 2008/0012806 A1
(43) Pub. Date: Jan. 17, 2008

(54) Moving image display device and moving image display method

(75) Inventors: Kesatoshi Takeuchi, Shiojiri-shi (JP); Takahiro Sagawa, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 11/798,444

(22) Filed: May 14, 2007

(30) Foreign Application Priority Data
Jul. 12, 2006 (JP) 2006-191351

(51) Int. Cl. G09G 3/34; G09G 3/20

(52) U.S. Cl. 345/84; 345/55

(57) ABSTRACT

A moving image display device for displaying a moving image based on moving image data includes a plurality of display elements arranged in a matrix configuration and a driver configured to drive the plurality of display elements. The plurality of display elements are divided into i (where i is an integer not lower than 2) groups respectively containing a predetermined number of rows of the display elements. The driver sequentially selects the display elements row by row in parallel for the respective i display element groups and provides the selected display elements with a drive signal in accordance with the moving image data.

### CROSS REFERENCE TO RELATED APPLICATIONS

The present application claims the priority based on Japanese Patent Application No. 2006-191351 filed on Jul. 12, 2006, the disclosure of which is hereby incorporated herein by reference in its entirety.

### BACKGROUND

1. Technical Field

The present invention relates to a moving image display device and to a moving image display method.

2 . Description of the Related Art

In the past, during display of a moving image on a moving image display device such as a television or projector, flicker (hereinafter termed “moving image flicker”) was sometimes noticeable in areas representing moving objects in the moving image. It is thought that such moving image flicker typically occurs in switching of the display between frame images by means of scanning, due to the human visual faculty simultaneously perceiving both the frame image before switching and the frame image after switching. Such moving image flicker tends to easily occur in moving image display devices (hereinafter termed “storage type display devices”) whose pixels are composed of storage type display elements, such as liquid crystal display devices that employ liquid crystal panels.

Various technologies have been proposed for improving display properties during display of moving images in moving image display devices (in JP2003-66918A and JP2001-42282A, for example). JP2003-66918A discloses a technology for compressing the frame images making up a moving image by one-half in the vertical direction, as well as carrying out scanning by simultaneously providing the same image signal to each of two adjacent lines on the display element array, thereby shortening by one-half the period required for scanning the entire screen. In the frame cycles, periods except for the scanning periods are utilized as blanking periods in which a black image is displayed.

According to the technology disclosed in JP2003-66918A, the scanning periods, that is, periods in which both the frame image before switching and the frame image after switching are perceived simultaneously, are shorter, and for this reason moving image flicker occurring during display of moving images is thought to be suppressed. However, since the technology disclosed in JP2003-66918A involves vertical compression of the frame images making up a moving image, the vertical resolution will be lower. Thus, while the technology disclosed in JP2003-66918A can improve display properties during moving image display, it carries the risk that the quality of the moving images will be diminished.

### SUMMARY

An object of the present invention is to provide a technology whereby it is possible to improve display properties during display of moving images, while preventing a drop in quality of the moving images.

In one aspect of the present invention, there is provided a moving image display device for displaying a moving image based on moving image data. The moving image display device comprises a plurality of display elements arranged in a matrix configuration and a driver configured to drive the plurality of display elements. The plurality of display elements are divided into i (where i is an integer not lower than 2) groups respectively containing a predetermined number of rows of the display elements. The driver sequentially selects the display elements row by row in parallel for the respective i display element groups and provides the selected display elements with a drive signal in accordance with the moving image data.

In accordance with this moving image display device, the driver sequentially selects the display elements row by row in parallel for the respective i display element groups. The driver also provides the selected display elements with a drive signal in accordance with the moving image data, in parallel for the respective i display element groups. Thus, in this moving image display device the scanning period can be shortened, and the moving image flicker can be suppressed. Moreover, in this moving image display device there is no reduction of vertical resolution. Consequently, with this moving image display device, display properties during display of a moving image can be improved, while preventing reduced quality of the moving image.

The present invention can be realized in various aspects. For example, the present invention can be realized in aspects such as a moving image display method and associated apparatus, a moving image compensation method and associated apparatus, a moving image correction method and associated apparatus, a moving image output method and associated apparatus, a computer program that executes the functions of these methods and apparatuses, a recording medium on which such computer program is recorded, a computer program product that includes this recording medium, or a data signal encoded in a carrier wave that incorporates this computer program.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a schematic illustration of the configuration of the moving image display device 100 according to Embodiment 1 of the present invention;

FIG. 2 is a timing chart of image data processing by the display device driver 150;

FIGS. 3A through 3D are conceptual illustrations of correspondence between a frame image and divided images;

FIG. 4 is an illustration depicting in detail the configuration of the display device 200;

FIG. 5 is an illustration depicting in detail the configuration of the liquid crystal panel module 300;

FIG. 6 is a drive timing chart of the liquid crystal panel module 300;

FIGS. 7A through 7D are conceptual illustrations of scanning in the first embodiment;

FIG. 8 is a schematic illustration of the configuration of the moving image display device 100a according to Embodiment 2 of the present invention; and

FIG. 9 is a drive timing chart of the liquid crystal panel module 300 in Embodiment 2.

### DESCRIPTION OF THE PREFERRED EMBODIMENT

Next, aspects of the present invention will be described in the following order on the basis of embodiments:
A. Embodiment 1
B. Embodiment 2
C. Variations

### A. Embodiment 1

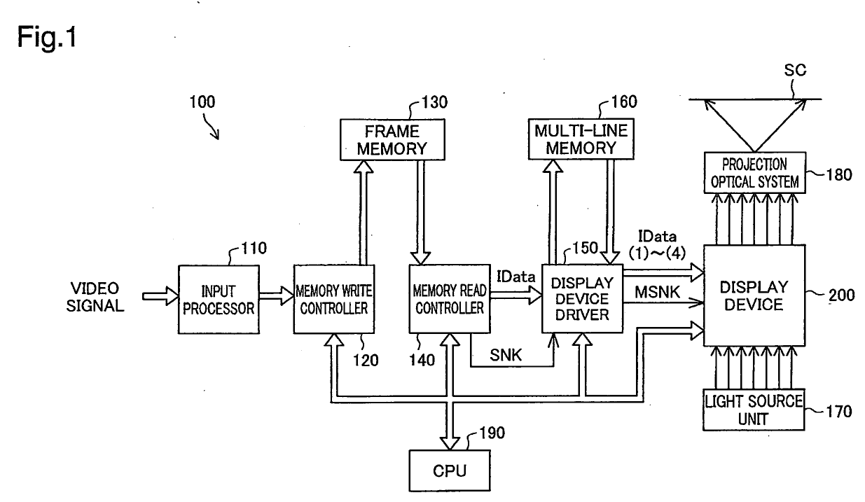

FIG. 1 is a schematic illustration of the configuration of a moving image display device 100 according to Embodiment 1 of the present invention. The moving image display device 100 of the first embodiment of the present invention is configured as liquid crystal projector. The moving image display device 100 includes an input processor 110, a memory write controller 120, a frame memory 130, a memory read controller 140, a display device driver 150, a multi-line memory 160, a display device 200, a light source unit 170, a projection optical system 180, and a CPU 190. The CPU 190 performs control of the entire moving image display device 100.

As will be discussed later, the display device 200 of the present embodiment is configured as a display device of storage type employing a liquid crystal panel. The light source unit 170 directs illuminant light towards the liquid crystal panel within the display device 200. The projection optical system 180 projects an image onto a screen SC by means of focusing onto the screen SC light (image light) that has been produced by the light source unit 170 and then converted by the liquid crystal panel within the display device 200, so as to represent an image.

The input processor 110 inputs a video signal such as a composite signal, S video signal, or component signal from a DVD player, video deck, PC or other external device, and converts it to a signal that can be processed by the memory write controller 120. In the present embodiment, the input video signal is an analog video signal composed of 30 frame images per second.

The input processor 110 separates a vertical sync signal Vs and a horizontal sync signal Hs from the input video signal, and generates a dot clock based on the cycle of the vertical sync signal Vs and horizontal sync signal Hs using a PLL circuit or the like. The input processor 110 converts the analog video signal separated from a sync signal SNK into a digital video signal.

The memory write controller 120, in sync with the sync signal SNK, sequentially writes the frame images contained in the digital video signal output from the input processor 110 to the frame memory 130.

The memory read controller 140, in sync with the sync signal SNK, reads out frame images that have been written to the frame memory 130. If necessary, the memory read controller 140 also enlarges or reduces the read out frame images to the appropriate resolution for the liquid crystal panel inside the display device 200, to be mentioned later. Enlargement/reduction of frame images may also be carried out when the memory write controller 120 writes the frame images to the frame memory 130. The memory read controller 140 provides the frame images as image data IData, together with the sync signal SNK, to the display device driver 150.

The display device driver 150, utilizing the multi-line memory 160, drives the display device 200 on the basis of the image data IData supplied by the memory read controller 140. Specifically, the display device driver 150 provides the display device 200 with the image data IData in the form of divided image data IData (1) to IData (4). The combination of the display device driver 150 and the multi-line memory 160 correspond to the drive signal output portion of the present invention. The multi-line memory 160 corresponds to the data storage portion of the present invention.

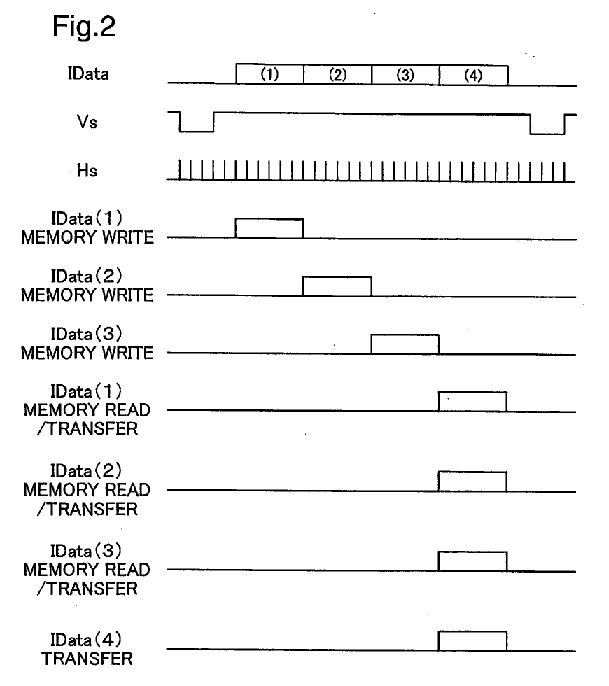

FIG. 2 is a timing chart of image data processing by the display device driver 150. The timing at which image data IData for one frame image is supplied from the memory read controller 140 to the display device driver 150, and the sync signal SNK (the vertical sync signal Vs and the horizontal sync signal Hs) of the image data IData, are shown at top in FIG. 2. In the present embodiment, the image data derived by dividing image data IData for one frame image into four segments along the time axis are denoted as divided image data IData (1) through IData (4). The images represented by the divided image data IData (1) through IData (4) are denoted as divided images (1) through (4).

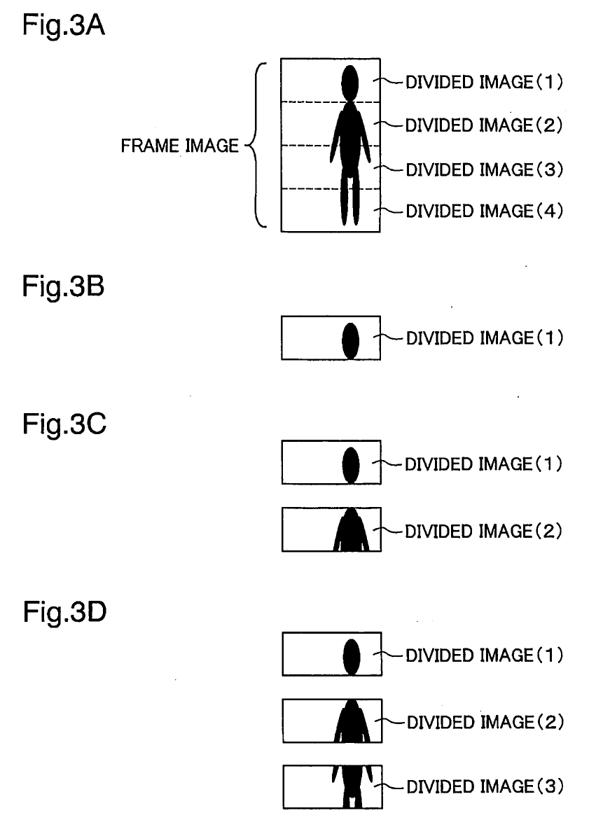

FIGS. 3A through 3D are conceptual illustrations of correspondence between a frame image and divided images. As shown in FIG. 3A, the divided images are images obtained by dividing the frame image into four parts in the vertical direction.

As shown in FIG. 2, for the segment of the initial one-fourth of the image data IData supplied from the memory read controller 140, the display device driver 150 (FIG. 1) receives the data, and in parallel therewith writes the received data as divided image data IData (1) into the multi-line memory 160. By so doing, a divided image (1) like that shown in FIG. 3B is written into the multi-line memory 160.

Similarly, for the segment of the next one-fourth of the image data IData, the display device driver 150 writes the received data as divided image data IData (2) into the multi-line memory 160 (see FIG. 3C). Then, for the segment of the further next one-fourth of the image data IData, the display device driver 150 writes the received data as divided image data IData (3) into the multi-line memory 160 (see FIG. 3D). At this point in time, the divided images (1) through (3) have been written in the multi-line memory 160.

Subsequently, the display device driver 150 receives the segment of the final one-fourth of the image data IData, and as shown in FIG. 2, in parallel with receipt of the data at this time, transfers the received data as divided image data IData (4) to the display device 200. Furthermore, during transfer of this divided image data IData (4), the display device driver 150 carries out the parallel operations of reading out the divided image data IData (1) through IData (3) that has been written into the multi-line memory 160, and transferring this data to the display device 200. By so doing, the divided image data IData (1) through IData (4) is transferred in parallel from the display device driver 150 to the display device 200.

On the basis of the sync signal SNK, the display device driver 150 generates a horizontal sync signal MHs, a vertical sync signal Mvs, and a dot clock MDCLK for the purpose of driving the display device 200, and provides these signals to the display device 200. For convenience, the horizontal sync signal MHs, a vertical sync signal MVs, and a dot clock MDCLK are collectively designated as the sync signal MSNK.

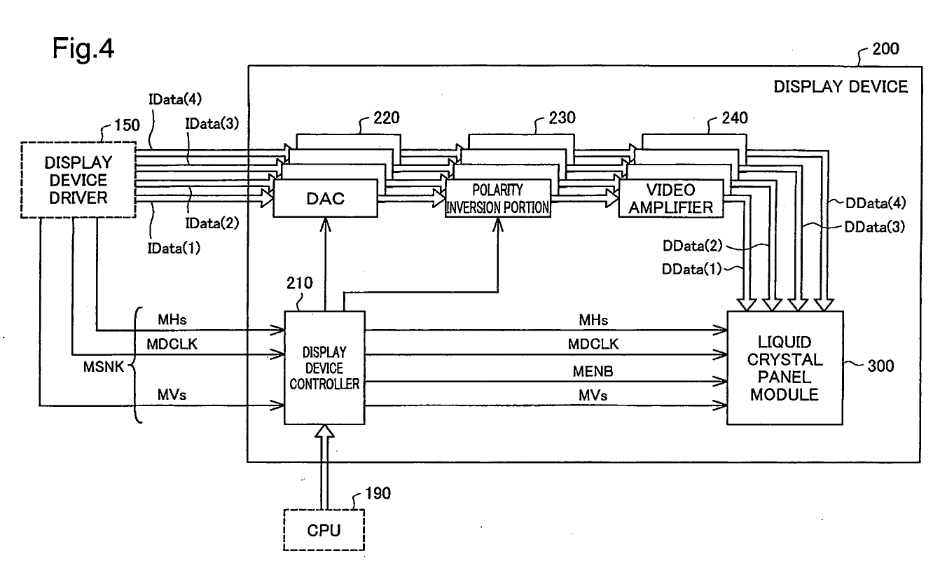

FIG. 4 is an illustration depicting in detail the configuration of the display device 200. As shown in FIG. 4, the display device 200 includes a display device controller 210, a D/A converter 220 (hereinafter DAC 220), a polarity inversion portion 230, a video amplifier 240, and a liquid crystal panel module 300.

The display device controller 210, in accordance with the sync signal MSNK supplied by the display device driver 150 (FIG. 1) and under control by the CPU 190, performs overall control of the display device 200. The display device controller 210 generates an enable signal MENB and provides the enable signal MENB, together with the sync signal MSNK, to the liquid crystal panel module 300.

As shown in FIG. 4, the display device 200 includes four sets each composed of a DAC 220, a polarity inversion portion 230, a video amplifier 240. These four sets correspond to the four divided image data IData (1) through IData (4). Specifically, of the four divided image data IData segments supplied by the display device driver 150, the divided image data IData (1) is converted into an analog signal by one of the DACs 220, subjected to a polarity inversion process by one of the polarity inversion portions 230, and amplified by one of the video amplifiers 240, thereby becoming converted to drive data DData (1) for driving the liquid crystal panel module 300. The drive data DData (1) is then provided to the liquid crystal panel module 300. In the present embodiment, it is possible for the drive signal output portion in the present invention to correspond to the DAC 220, the polarity inversion portion 230, and the video amplifier 240 in addition to the display device driver 150 and the multi-line memory 160.

The other divided image data segments (divided image data IData (2) through (4)) similarly undergo processing by the other DACs 220, polarity inversion portions 230, and video amplifiers 240, becoming converted to drive data DData (2) through (4). The drive data DData (2) through (4) is also provided to the liquid crystal panel module 300.

In the present embodiment, as described above, the divided image data IData (1) through IData (4) is transferred in parallel from the display device driver 150 to the display device 200, whereby provision of the drive data DData (1) through (4) to the liquid crystal panel module 300 is also carried out in parallel.

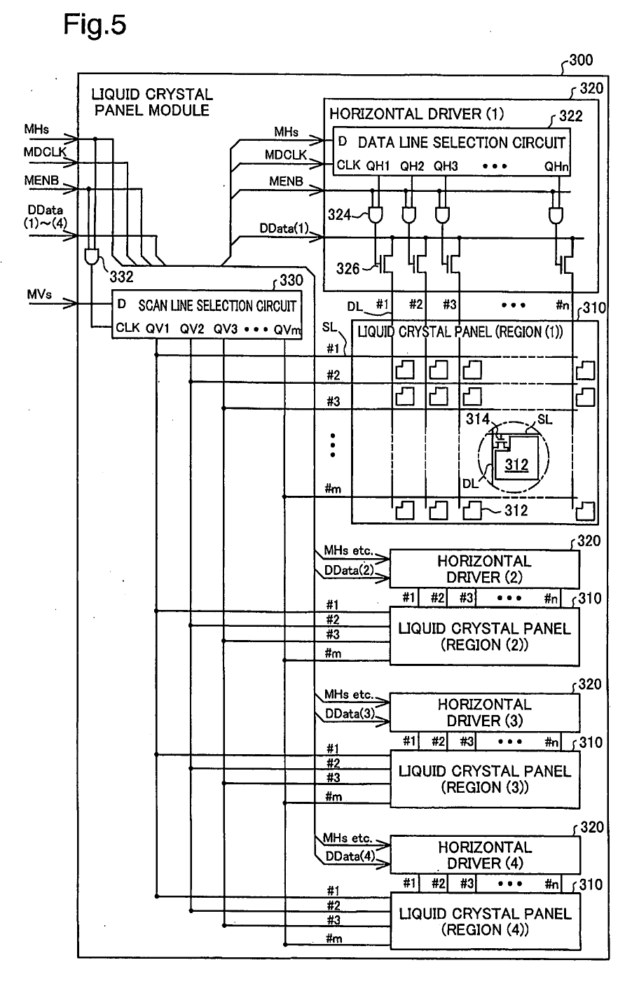

FIG. 5 is an illustration depicting in detail the configuration of the liquid crystal panel module 300. As shown in FIG. 5, the liquid crystal panel module 300 includes a liquid crystal panel 310, a horizontal driver 320, and a scan line selection circuit 330. The horizontal driver 320 and the scan line selection circuit 330 correspond to the driver in the present invention.

As shown in FIG. 5, in the present embodiment, the liquid crystal panel 310 included in the liquid crystal panel module 300 is divided into four regions (regions (1) through (4)). In each region of the liquid crystal panel 310, liquid crystal elements 312 are disposed in an m×n matrix array corresponding to the respective intersections of m scan lines SL with n data lines. That is, a total of 4 m×n liquid crystal elements 312 are disposed in the liquid crystal panel 310. The liquid crystal elements 312 are connected to data lines DL via switching elements 314 ( composed of TFTs for example) that are opened or closed in accordance with signals on the scan lines SL; the liquid crystal elements 312 perform tone representation in accordance with drive signals (voltage signals) provided from the data lines DL.

In FIG. 5, the regions of the liquid crystal panel 310 (regions (1) through (4)) are represented as being at separate locations, but in actual practice the four regions of the liquid crystal panel 310 as a whole function as a single liquid crystal panel. In FIG. 5, some of the liquid crystal elements 312 disposed in region (1) of the liquid crystal panel 310, and the liquid crystal elements 312 disposed in the other regions (regions (2) through (4)) have been omitted in the drawing.

The configuration of this sort of liquid crystal panel 310 could also be grasped as follows. In the present embodiment, the total of 4 m×n liquid crystal elements 312 disposed in the liquid crystal panel 310 are grouped into four liquid crystal element groups (collections of liquid crystal elements 312 disposed in each region of the liquid crystal panel 310) each containing m lines of liquid crystal elements 312.

The liquid crystal panel module 300 is furnished with four horizontal drivers 320 (horizontal drivers (1) through (4)) associated with the four regions of the liquid crystal panel 310. Each horizontal driver 320 includes a data line selection circuit 322 composed of a shift register. In FIG. 5, only the internal configuration of the horizontal driver (1) associated with region (1) of the liquid crystal panel 310 is illustrated in detail, but the other horizontal drivers 320 have the same configuration.

The liquid crystal panel module 300 is also furnished with one scan line selection circuit 330. The scan line selection circuit 330, like the data line selection circuit 322, is composed of a shift register.

As mentioned earlier, the liquid crystal panel module 300 is provided with signals for driving the liquid crystal panel module 300. Specifically, as shown in FIG. 4, the liquid crystal panel module 300 is provided by the display device controller 210 with the horizontal sync signal MHs, the vertical sync signal MVs, the dot clock MDCLK, and the enable signal MENB. The liquid crystal panel module 300 is also provided with the drive data DData (1) through (4), via the video amplifiers 240.

The data input terminal (D) of the scan line selection circuit 330 (FIG. 5) is provided with the vertical sync signal MVs. The clock input terminal (CLK) of the scan line selection circuit 330 is provided with the output of an AND circuit 332 having as inputs the horizontal sync signal MHs and the enable signal MENB.

Meanwhile, data input terminal (D) of the data line selection circuit 332 of each of the horizontal drivers 320 is provided with the horizontal sync signal MHs, and the clock input terminal (CLK) of the data line selection circuit 332 is provided with the dot clock MDCLK. The horizontal driver 320 associated with region (1) of the liquid crystal panel 310 (i.e. the horizontal driver (1)) is provided with the drive data DData (1); then the drive data DData (1) is supplied to a data line DL via a switching element 326. Similarly, the horizontal drivers 320 associated with regions (2) through (4) of the liquid crystal panel 310 (i.e. the horizontal drivers (2) through (4)) are provided with the drive data DData (2) through (4). The horizontal drivers 320 are also provided with the enable signal MENB, supplied as one input to n AND circuits 324 which are provided in association with the columns of liquid crystal elements 312. The other input of the AND circuits 324 is the output from the output terminal of the data line selection circuit 322; the outputs from the output terminals of the AND circuits 324 are input to the gates of the switching elements 326.

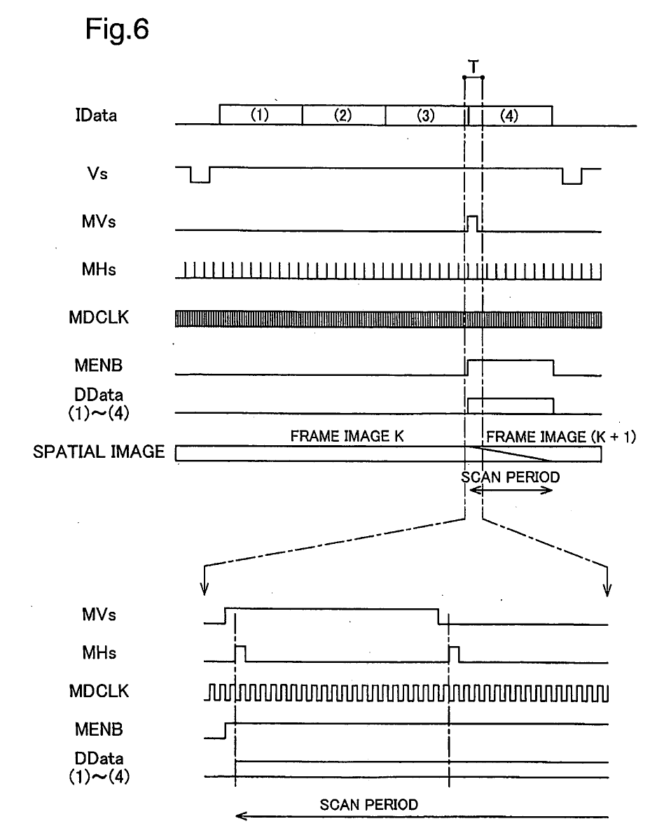

FIG. 6 is a drive timing chart of the liquid crystal panel module 300. A timing chart for an interval equivalent to one frame image is shown in FIG. 6. The vertical sync signal Vs of the input video signal is shown at top in FIG. 6. In the bottom part of FIG. 6, several of these signals during a specific interval T are depicted in enlarged view.

The vertical sync signal MVs goes to H level at a point in time approximately three-fourths through the period equivalent to one frame image. At the same time that the vertical sync signal MVs goes to H level, the enable signal MENB goes to H level as well, and remains at H level until the approximate end of the period equivalent to one frame image. Thus, for the duration that the enable signal MENB is H level, H level signals shifted sequentially at the cycle of the horizontal sync signal MHs are output from the output terminals QV1, QV2, QV3, . . . QVm of the scan line selection circuit 330 (FIG. 5). The output terminals QV1, QV2, QV3, . . . QVm are respectively connected to the scan lines SL of rows 1, 2, 3, . . . m of each region of the liquid crystal panel 310. Thus, at the cycle of the horizontal sync signal MHs, H level signals are supplied sequentially to the scan lines SL of row 1 to row m of each region by means of the scan line selection circuit 330, and the liquid crystal elements 312 are electrically connected with the data lines CL via the switching elements 314. That is, the liquid crystal elements 312 are selected in row units in sequence from row 1 to row m by the scan line selection circuit 330, in parallel for each region of the liquid crystal panel 310.

Meanwhile, H level signals shifted sequentially at the cycle of the dot clock MDCLK are output from the output terminals QH1, QH2, QH3 QHn of the data selection circuit 322 of each of the horizontal drivers 320. Here, the cycle of the dot clock MDCLK is equivalent to 1/n of the cycle of the horizontal sync signal MHs.

During the period that the enable signal MENB is H level, the outputs of the output terminals QH1, QH2, QH3 . . . , QHn of the data selection circuit 322 are supplied to the gates of the switching elements 326 through the AND circuits 324. Thus, the switching elements 326 go ON in sequence from row 1 to row m at the cycle of the dot clock MDCLK. Once the switching elements 326 go ON, the drive data DData is supplied to the data line DL, and the liquid crystal elements 312 of the row selected by the scan line SL perform tone representation according to the drive data DData.

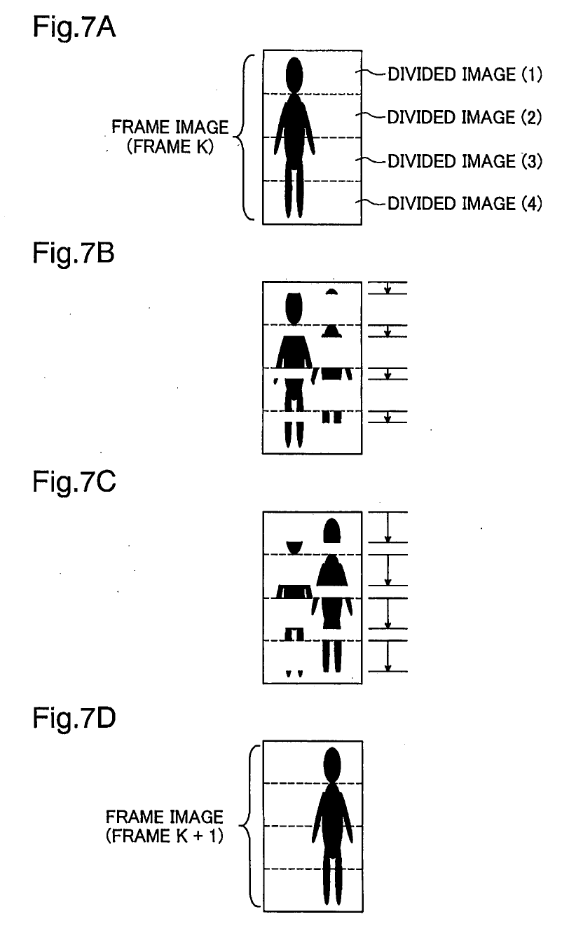

In the present embodiment, scanning is performed in this way, in parallel for each of the regions (regions (1) through (4)) of the liquid crystal panel 310. FIGS. 7A through 7D are conceptual illustrations of scanning in the first embodiment. FIG. 7A depicts a given frame image (the frame image of frame K) being displayed on the liquid crystal panel 310 (FIG. 5). As shown in FIGS. 7B and 7C, in the present embodiment, scanning is performed in parallel in the regions (1) through (4) of the liquid crystal panel 310. FIG. 7D depicts scanning equivalent to one frame image being completed, and the next frame image (the frame image of frame (K+1)) being displayed. In FIG. 6, the timing of switching from the frame image of frame K to the frame image of frame (K+1) is shown as the spatial image displayed on the liquid crystal panel 310.

In the present embodiment, scanning is performed in this way in parallel for each of the regions of the liquid crystal panel 310, and therefore the time required for a scan is reduced to one-forth that needed where scanning is performed in point sequential fashion for entire liquid crystal panel 310, as done conventionally. A shorter scan time typically reduces moving image flicker occurring during moving image display. Thus, with the moving image display device 100 of the present embodiment, the occurrence of moving image flicker can be reduced and the display properties of the moving image can be improved. Moreover, with the moving image display device 100 of the present embodiment, each region of the liquid crystal panel 310 is furnished with a dedicated horizontal driver 320, and the drive data DData is supplied in parallel to the horizontal drivers 320, so there is no reduction in the vertical resolution of the frame images making up the moving image. Thus, with the moving image display device 100 of the present embodiment it is possible to improve moving image display properties while preventing a decline in quality of the moving image.

### B. Embodiment 2

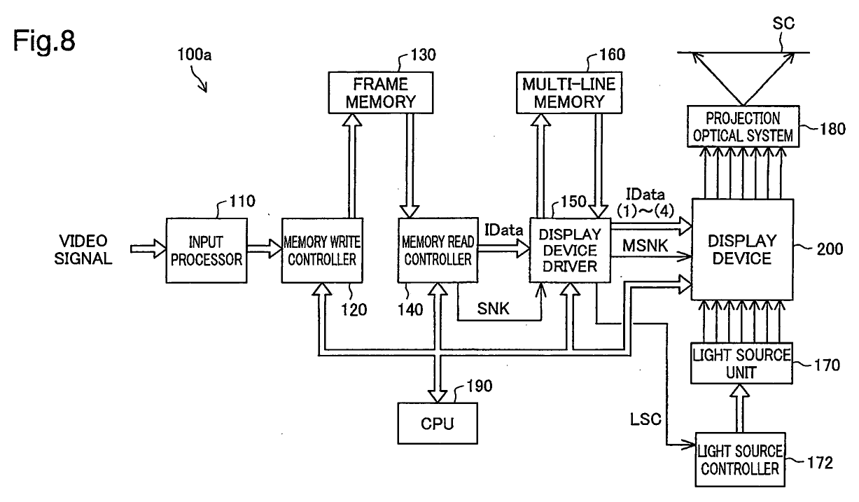

FIG. 8 is a schematic illustration of the configuration of a moving image display device 100a according to Embodiment 2 of the present invention. The moving image display device 100a of Embodiment 2 differs from the moving image display device 100 of Embodiment 1 in that the formed is furnished with a light source controller 172.

The light source controller 172 variably controls the luminance of the light source unit 170, by means of variable control of the lighting power supplied to the light source unit 170, on the basis of a light source control signal LSC input from the display device driver 150.

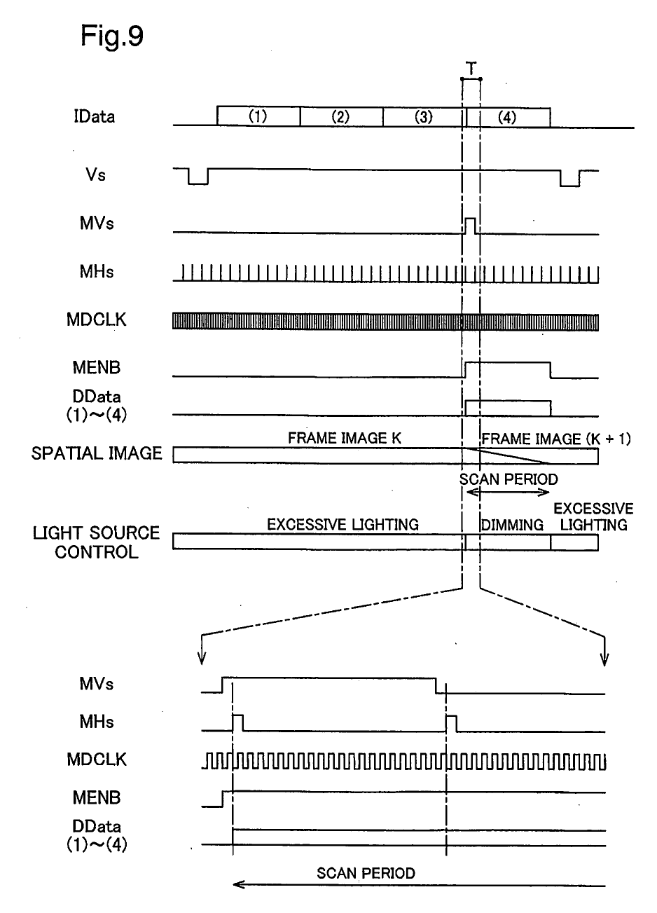

FIG. 9 is a drive timing chart of the liquid crystal panel module 300 (FIG. 4) in Embodiment 2. In Embodiment 2, luminance control of the light source is performed during driving of the liquid crystal panel module 300, but drive timing is otherwise the same as in Embodiment 1. That is, the drive timing chart in Embodiment 2 depicted in FIG. 9 indicates timing for control of the light source, in addition to the drive timing chart in Embodiment 1 depicted in FIG. 6.

As shown in FIG. 9, in Embodiment 2, during scanning periods in which scanning is carried out, the light source controller 172 (FIG. 8) reduces the lighting power supplied to the light source unit 170, thus reducing the luminance of the light source unit 170. During these periods (hereinafter termed “dimming periods”), the luminance of the light source unit 170 is low in comparison with the luminance of the light source unit 170 when luminance control is not being performed (hereinafter termed “normal driving”). Meanwhile, at times except for scanning periods, the light source controller 172 increases the lighting power supplied to the light source unit 170. During these periods (hereinafter termed “excessive lighting periods”), the luminance of the light source unit 170 is high in comparison with the luminance of the light source unit 170 during normal driving.

In the present embodiment, the lighting power Po(W) in the excessive lighting periods is computed using Equation (1) below. By controlling the light source unit 170 using lighting power Po(W) given by Equation (1) in the excessive lighting period, it is possible to prevent a drop in brightness of the moving image as a whole.

Po=Pty×(To+Tu)/To (1)
Pty: lighting power during normal driving
To: excessive lighting period (s)
Tu: dimming period (s)

As described hereinabove, in Embodiment 2, light source control is carried out so that the light source unit 170 produces low luminance during scanning periods in which scanning is carried out. Thus, the scanning period serves as the so-called blanking period, and the occurrence of moving image blurring is reduced. Consequently, the moving image display device 100a of Embodiment 2 affords further improvement in display properties of moving images, while preventing a drop in quality of the moving image.

### C. Variations

The present invention is not limited to the embodiments and aspects described above. The present invention may be worked in various aspects within limits that involve no departure from the spirit of the invention; for example, the following variations are possible.

### C1. Variation 1

While the preceding embodiments took the example of a projector configuration of the moving image display device 100, it would be possible for the moving image display device to instead be configured as a liquid crystal display, a CRT display, a plasma display, and SED, or the like. In this case, the display device driver 150, the display device 200 and so on depicted in FIG. 1 would be replaced with other drive circuits and display devices appropriate to the display apparatus. In some instances, the light source unit 170 or the projection optical system 180 may not be necessary.

### C2. Variation 2

In the preceding embodiments, the liquid crystal panel 310 (FIG. 5) is divided into four regions, but the number of regions into which the liquid crystal panel 310 is divided can be set to any number that is an integer equal to 2 or greater. In the preceding embodiments, the liquid crystal panel 310 can be divided into a maximum of 4m regions. A larger number of regions of the liquid crystal panel 310 means that the scanning period can be shorter, and the moving image display qualities can be improved even further.

Moreover, whereas in the preceding embodiments, four horizontal drivers 320 are provided in association with the four regions of the liquid crystal panel 310, it is not always necessary to provide independent horizontal drivers 320 in equal number to the number of regions of the liquid crystal panel 310. For example, it would be possible to provide only switching elements 326 (FIG. 5) associated with each region of the liquid crystal panel 310, and to provide only a single data selection circuit 322 and AND circuit 324 for common use by the regions.

### C3. Variation 3

In the preceding embodiments, all of the regions of the liquid crystal panel 310 in the moving image display device 100 are scanned at common (i.e. identical) timing. Specifically, in each region of the liquid crystal panel 310, row selection is carried out at identical timing and drive signals are supplied to the liquid crystal elements 312 at identical timing. However, as long as scanning is carried out in parallel for each of the regions of the liquid crystal panel 310, it is not necessary for scanning to be carried out at common timing. Here, carrying out scanning in parallel means providing a drive signal with at least one liquid crystal element 312 included in at least one other region, during a period in which the drive signal is provided to all of the liquid crystal 312 contained within one region of the liquid crystal panel 310.

### C4. Variation 4

In the preceding embodiments, some of the arrangements realized through hardware may be replaced by software, and conversely some of the arrangements realized through software may be replaced by hardware.

What is claimed is:

1. A moving image display device for displaying a moving image based on moving image data, comprising:
a plurality of display elements arranged in a matrix configuration, the plurality of display elements being divided into i (where i is an integer not lower than 2) groups respectively containing a predetermined number of rows of the display elements; and
a driver configured to drive the plurality of display elements,
wherein the driver sequentially selects the display elements row by row in parallel for the respective i display element groups and provides the selected display elements with a drive signal in accordance with the moving image data.

2. A moving image display device according to claim 1, wherein the driver drives the plurality of display elements in such a way that, during a period of time in which the drive signal is provided to all of the display elements contained in one of the display element groups, the drive signal is provided to at least one display element contained in at least one other display element group.

3. A moving image display device according to claim 1, wherein the i display element groups respectively include identical numbers of rows of the display elements, and
the driver selects the display elements and provides the drive signal to the selected display elements under common timing for all of the display element groups.

4. A moving image display device according to claim 1, further comprising:
a drive signal output portion configured to generate, on the basis of the moving image data, i drive signals for provision to the i display element groups, and configured to output the i drive signals in parallel to the driver.

5. A moving image display device according to claim 4, wherein
the moving image data is composed of multiple frame image data, and
the drive signal output portion includes a data storage portion for storing part of the frame image data corresponding to at least (i−1) of the display element groups.

6. A moving image display device according to claim 1, further comprising:
a light source configured to direct light onto the plurality of display elements and configured to generate image light representing an image; and
a light source controller configured to for control the light source in such a way that, during a period of time in which the driver provides the drive signal to the plurality of display elements, the light emitted by the light source is of lower luminance as compared to that during other period of time.

7. A moving image display device according to claim 6, wherein
the light source controller controls the light source in such a way that, during the other period of time, the light emitted by the light source is of increased luminance, as compared to the case where control for changing the luminance of the light emitted by the light source is not carried out.

8. A moving image display method for displaying a moving image based on moving image data, comprising the steps of
(a) preparing a plurality of display elements arranged in a matrix configuration, the plurality of display elements being divided into i (where i is an integer not lower than 2) groups respectively containing a predetermined number of rows of the display elements; and
(b) driving the plurality of display elements, by sequentially selecting the display elements row by row in parallel for the respective i display element groups and providing the selected display elements with a drive signal in accordance with the moving image data.
